(19) United States
(12) Patent Application Publication
(10) Pub. No.: US 2019/0211684 A1
(43) Pub. Date: Jul. 11, 2019

(54) METHOD FOR ADDITIVE MANUFACTURING BY MEANS OF A POROUS AUXILIARY STRUCTURE, COMPONENT AND DEVICE

(71) Applicant: Siemens Aktiengesellschaft, Munich (DE)

(72) Inventor: Bernd Burbaum, Falkensee (DE)

(73) Assignee: Siemens Aktiengesellschaft, Munich (DE)

(21) Appl. No.: 16/325,823

(22) PCT Filed: Sep. 4, 2017
(86) PCT No.: PCT/EP2017/072091

§ 371 Date: Feb. 15, 2019

(30) Foreign Application Priority Data
Sep. 5, 2016 (DE) 10 2016 216 721.9

(51) Int. Cl. F01D 5/14; F01D 9/02; B33Y 10/00; B33Y 30/00; B33Y 80/00; B23K 26/34; B23K 26/354

(52) U.S. Cl. CPC F01D 5/147; F01D 9/02; B33Y 10/00; F05D 2230/312; B33Y 80/00; B23K 26/34; B23K 26/354; B33Y 30/00

(57) ABSTRACT

A method for the additive manufacturing of a component includes: the additive building up of a structure from a base material for the component by an additive manufacturing method; the introduction, during the additive building up of the structure, of a porous auxiliary structure into an interior of the structure to define a functional area for the component in the interior; and the removing, in particular melting, of the porous auxiliary structure from the functional area by heating the auxiliary structure so that the functional area no longer has the auxiliary structure. A component is produced in accordance with the method and a corresponding device.

### CROSS REFERENCE TO RELATED APPLICATIONS

This application is the US National Stage of International Application No. PCT/EP2017/072091 filed Sep. 4, 2017, and claims the benefit thereof. The International Application claims the benefit of German Application No. DE 10 2016 216 721.9 filed Sep. 5, 2016. All of the applications are incorporated by reference herein in their entirety.

### FIELD OF INVENTION

The present invention relates to a method for the additive manufacturing of a component, in particular with the use of a porous auxiliary structure, and to a correspondingly produced or producible component. The present invention further relates to a corresponding device for the additive manufacturing of the component.

The component may be provided for use in a turbomachine, or a gas turbine. The component is of a nickel- or cobalt-based alloy or of a corresponding superalloy or comprises such an alloy. Said alloy can be precipitation-hardened or precipitation-hardenable. The component can, alternatively or in addition, comprise or consist of a high-temperature-resistant and/or highly heatproof alloy.

The component may be used in a hot-gas path or hot-gas region of a turbomachine, such as a gas turbine.

### BACKGROUND OF INVENTION

Generative or additive manufacturing methods comprise, for example, beam melting and/or beam welding methods. These include in particular selective laser melting (SLM) and laser deposition welding (also known as laser metal deposition (LMD)), in particular laser powder deposition welding.

A method for deposition welding is known from EP 2 756 909 A1, for example.

U.S. Pat. No. 6,410,105 B1 further describes the additive building up of overhanging structures or cavities in the context of laser deposition welding methods.

US 2015/321289 A1 describes the additive building up in layers of metallic foam structures on a substrate for the production of turbine components.

Additive manufacturing methods have proved to be particularly advantageous for complex components or components of complicated or delicate design, for example labyrinth-like structures, cooling structures and/or lightweight structures.

Additive manufacturing is particularly advantageous, in particular through a particularly short chain of process steps, since a manufacturing or fabrication step of a component can occur directly on the basis of a corresponding CAD- or computer-readable construction data file. Furthermore, additive manufacturing is particularly advantageous for the development or production of prototypes which, for example for cost reasons, cannot be efficiently produced, if at all, by means of conventional subtractive or cutting methods or casting technology.

A problem which is linked with the additive manufacturing, which is technologically gaining in importance, of components, in particular of components consisting of high-performance materials, is the difficulty of producing interiors or internal hollow structures of the components with a sufficient accuracy and quality. In particular, it is generally difficult to build up inner or internal structures, since overhangs or undercuts in the component must customarily be modeled by complicated supporting structures which subsequently have to be removed again in a complicated manner.

In the case of overhangs which are not all too large, it is possible under certain circumstances to dispense with supporting structures. However, it is necessary in any case, in particular in powder bed-based methods, for the powder, which is precisely not melted to form the interiors, to be removed again from the interiors after building up the structure of the component. Depending on the geometry of the interior, this is subsequently sometimes very difficult or impossible, since nonmelted powder also frequently “sinters on” as a result of the high temperatures or temperature gradients involved in the SLM process and thus a (complete) removal of the powder is additionally made more difficult or is prevented.

### SUMMARY OF INVENTION

It is therefore an object of the present invention to specify means which solve the stated problems. In particular, an alternative method for the additive building-up of components is presented, whereby cavities in components to be built up additively can be realized in a simplified manner. The method can be implemented by a laser deposition welding method. Also presented is a corresponding device for operating the stated method by which the stated problems can likewise be solved.

The object is achieved by the subject matter of the independent patent claims. Advantageous embodiments form the subject matter of the dependent patent claims.

One aspect of the present invention relates to a method for the additive manufacturing of a component, comprising the additive building-up of a structure from a base material for the component by means of an additive manufacturing method, such as by means of laser deposition welding or so-called “laser cladding”, a special form of laser deposition welding.

The stated structure is advantageously a, for example integrally bonded, coherent structure for the component.

The stated base material can be present in bar form or, advantageously, in powder form. Furthermore, in the present case, the base material can be designated as synonymous with the structure, with it being directly clear to a person skilled in the art that the composition of the pulverulent base or starting material can differ slightly from the consolidated/built-up structure.

The method further comprises introducing or building up a porous auxiliary structure into or in an interior of the structure during the additive building-up of the structure in order to define a functional region for the component in the interior. The fusion region can designate a cavity for the completely produced component.

The method further comprises the detachment or removal, in particular melting, liquefaction or destruction of the dimensional stability of the porous auxiliary structure in such a way that it is removed from the functional region by heating and the functional region is freed from the auxiliary structure. There is thus advantageously no longer an auxiliary structure in the functional region, which can constitute, for example, a cooling duct in the finished component. The auxiliary structure is advantageously simultaneously at least partially removed or detached from regions of the interior in order to form the functional region. The porous auxiliary structure can advantageously be introduced into the additive buildup during the additive manufacturing of the actual structure for the component and/or in situ, and thus a possible functional region or cavity can be defined in the interior of the component during the actual manufacturing. The auxiliary structure is further advantageously such that, by virtue of the removal described, it can be removed at least from the functional region in a simple manner. Here, the auxiliary structure does not necessarily have to be completely removed from the interior.

In one embodiment, parts of the structure and of the auxiliary structure are (additively) built up alternately in layers. This embodiment means that the component can be provided with a particularly complicated or delicate functional region or cavity. This embodiment can be implemented in that, advantageously in laser deposition welding, a corresponding starting material is changed (in layers) for the building-up of the structure or auxiliary structure and a device for this purpose is correspondingly “switched”.

According to one embodiment, it is also possible at first, for example, for a plurality of layers of the structure to be built up in succession, wherein the auxiliary structure can be introduced into the defined interior after the corresponding buildup, for example before overhangs or undercuts of the structure are consolidated.

In one embodiment, the auxiliary structure is introduced into the interior or built up therein, for example in layers, in such a way that the auxiliary structure supports the structure for the component. Accordingly, it is advantageously possible to dispense with additional supporting structures, for example those which can subsequently not be removed in a simple manner. The structure can accordingly be provided, in particular arranged and designed, to ensure a dimensional stability of the component or of its structure during the additive manufacturing.

The additive building-up of the structure and/or the introduction or building-up of the auxiliary structure are or is carried out by means of laser deposition welding or “micro cladding”. This makes it possible, in a particularly expedient and advantageous manner, to carry out the described method according to the invention.

In one embodiment, the additive building-up of the structure and the building-up of the auxiliary structure are carried out in the same device (see below). Moreover, this embodiment allows the method to be carried out in a particularly simple and time-efficient manner. This is necessary or required in particular since additive manufacturing, in spite of its known advantages and increasing technological importance, demands relatively long buildup times, of for example many hours, days or even weeks.

In one embodiment, the porous auxiliary structure is formed from a metal foam.

In one embodiment, the porous auxiliary structure and/or the stated metal foam have or has a porosity of 30%, 40%, 60% or 70%. In particular, the porosity is 50%.

In one embodiment, to form the auxiliary structure, an, in particular metallic, material, for example a solder material, is mixed with a pore former, in particular a metal hydride, for example a titanium hydride.

In one embodiment, the stated, in particular metallic material, is a solder material, advantageously a high-temperature solder.

In one embodiment, the stated mixture for forming the auxiliary structure is heated over the melting point of the, in particular metallic, material and the pore former is thereby evaporated. In this way, the pores for the porous (foam) material are formed.

The stated heating or heat is made available according to the invention by the described beam melting or beam welding process for the additive building-up of the structure, in particular the laser or electron beam heat of a deposition welding or processing head. This advantageously occurs in layers and directly at the location of the additive building-up (“in situ”).

In one embodiment, advantageously after completion of the component, an (auxiliary) material of the auxiliary structure at least partially remains in the interior. In other words, although the porous auxiliary structure is removed by a heating and the corresponding melting or liquefaction of the material of the auxiliary structure from the functional region, it can be difficult, depending on the geometry of the interior and/or the functional region, to remove the stated structure material likewise from the interior. In accordance with the porosity set, it is then possible for more or less volume to be available for the functional region.

In one embodiment, the structure for the component is built up in such a way that the component has at least one inlet and/or outlet which is fluidically connected to the interior. This is particularly expedient if the fusion region constitutes a cooling duct or flow duct for the component that has to be traversed by a cooling fluid for the corresponding cooling function during the operation of the component.

In one embodiment, the structure is designed in such a way that the auxiliary structure, advantageously after the additive building-up of the structure, can be removed from the interior in a simple manner by melting and/or liquefaction and subsequent flowing-out. In other words, a building-up direction for the additive building-up and/or the component geometry can be chosen beforehand, for example by already taking consideration thereof in a corresponding data model, such that one or more inlets or outlets for the functional region simultaneously serve as outlets for the (melted-down or liquefied) structure material.

A further aspect of the present invention relates to a component which is produced and/or is producible by the described method. In one embodiment, the component is a high-temperature-resistant and/or highly heatproof component, in particular for use in a turbomachine, such as a gas turbine.

In one embodiment, the functional region is provided, i.e. for example correspondingly arranged and designed, to be traversed by a fluid, in particular for cooling, wherein the functional region is further at least partially defined by the, in particular metallic, material. The, in particular metallic, material is advantageously the aforementioned solder material or auxiliary structure material for the auxiliary structure. This is advantageously a material which differs from the base material for the structure. The stated, in particular metallic, material advantageously has a lower melting point than the base or structure material for the component.

A further aspect of the present invention relates to a device for the additive manufacturing of the component, comprising a reservoir for the separate or separated storage of the, in particular pulverulent, base material for the component and of the, in particular metallic, material and of a further material. The further material can be a functional material, advantageously the stated pore former.

In one embodiment, the reservoir comprises three sub-reservoirs, wherein each sub-reservoir respectively holds or contains only one of the stated materials, selected from base material, in particular metallic material and further material.

The device further comprises a processing head which is connected to the reservoir or the sub-reservoirs, wherein the processing head is further designed for guiding a welding beam, in particular a laser or electron beam. The processing head is further designed in such a way as to selectively deposit the base material, the, in particular metallic, material and/or the further material onto a processing surface or a substrate and to melt said materials for the additive building-up.

The stated materials can be mixed in the processing head.

As ought to be known from the prior art, the stated building-up process can further be carried out under an inert gas atmosphere.

In one embodiment, the processing head comprises a welding or melting head with a powder feed or powder nozzle and also a laser or electron beam optics, advantageously in coaxial arrangement.

The device is a beam welding device and/or a beam melting device for laser deposition welding, particularly advantageously for laser powder deposition welding.

In one embodiment, the device comprises a delivery device for the, in particular fully automatic or semi-automatic, selective delivery of the base material, of the, in particular metallic, material and/or of the further material into the processing head.

In one embodiment, the device comprises an, in particular inductive, heating device which is designed to heat a structure of the component to a temperature of at least 800° C. According to this embodiment, the material of the auxiliary structure can be removed from the functional region in a particularly expedient manner, for example by melting down.

Embodiments, features and/or advantages which in the present case refer to the method or the component can also relate to the device, or vice versa.

### BRIEF DESCRIPTION OF THE DRAWINGS

Further details of the invention will be described below with reference to the figures.

FIG. 1 schematically shows a device according to the invention and indicates, by way of a cross-sectional view of a component, method steps of a method carried out according to the invention by the device.

FIG. 2 schematically shows an auxiliary structure for the additive building-up of the component.

FIG. 3 schematically indicates a further method step of the method.

FIG. 4 shows by way of example a component produced according to the method.

FIG. 5 shows a simplified flow diagram which indicates method steps according to the invention.

### DETAILED DESCRIPTION OF INVENTION

In the exemplary embodiments and figures, identical or identically acting elements can each be provided with the same reference signs. The illustrated elements and their size ratios relative to one another are, in principle, not to be considered as true to scale; rather, for better illustratability and/or for better comprehension, individual elements may be illustrated as exaggeratedly thick or largely dimensioned.

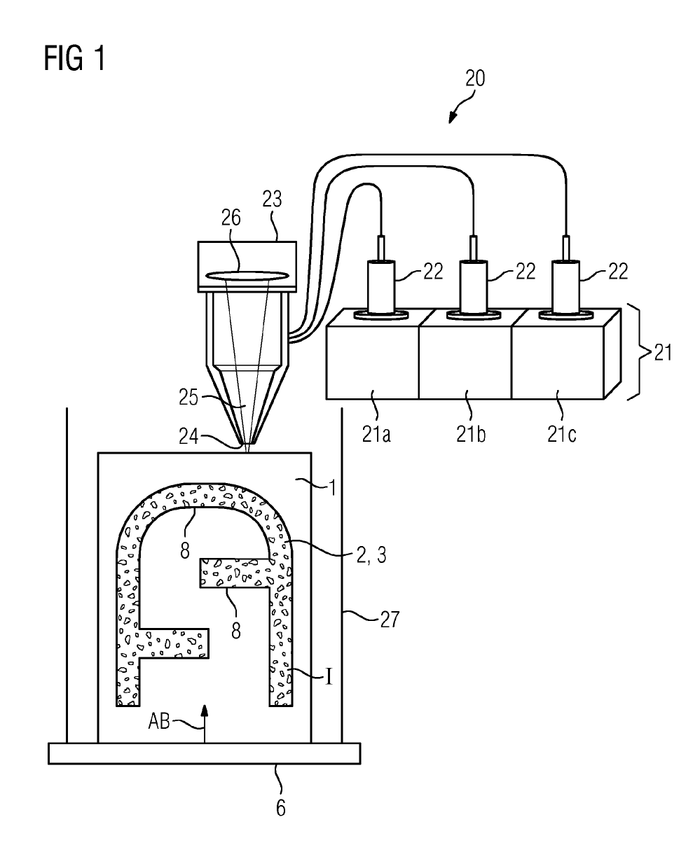

FIG. 1, in the upper part of the illustration, indicates a device 20 according to the invention in a simplified manner. In the lower part of the illustration there is schematically illustrated the additive building-up of a component in a cross-sectional view as part of a method according to the invention. In particular a structure 1 for the component 100 (cf. FIG. 3 below) according to the invention is indicated by way of example by means of the device 20. The method step of the additive building-up of the structure 1 is further designated in a simplified manner in the flow diagram of FIG. 5 by the reference sign a).

The component 100 is advantageously a component consisting of a nickel-based alloy or superalloy or another, in particular highly heatproof or high-temperature-resistant, component, in particular for use in a turbomachine, such as a gas turbine.

The device 20 is basically a beam welding and/or beam melting device, in particular a device for laser deposition welding, particularly advantageously for laser powder deposition welding or “micro cladding”.

The device 20 comprises a reservoir 21. The reservoir 21 advantageously holds or stores pulverulent starting and auxiliary materials for the additive building-up of the structure 1 by means of the device 20. The reservoir 21 can, as illustrated, be subdivided into three separate or mutually separated sub-reservoirs 21a, 21b and 21c, wherein each sub-reservoir contains only one material. Without limiting the generality, the sub-reservoir 21a can, for example, hold a base material for the structure 1 or the component 100.

For example, the sub-reservoir 21b holds or contains an, advantageously metallic, auxiliary material 3. The auxiliary material 3 can be an additive material which is of the same kind as or similar kind to the base material for the structure 1. For example, both materials, i.e. the base material and the auxiliary material 3, can be metallic. However, the respective melting points are advantageously different. The melting point of the auxiliary material 3 is advantageously lower than the melting point of the base material under standard pressure conditions.

The sub-reservoir 21c contains a further material, for example. The further material can likewise be an auxiliary material and/or a functional material (not explicitly indicated). In particular, the functional or further material is a pore former with which metallic foams and/or porous structures can be produced in interaction with the auxiliary material 3. The functional or further material can, for example, likewise be pulverulent or else liquid.

The device 20 further comprises a processing head 23 which is schematically indicated in FIG. 1. The processing head 23 is advantageously equipped with an optics 26 for guiding a welding beam 25, for example a laser or electron beam. The processing head 23 is further connected to the reservoir 21, to be more precise to each of the sub-reservoirs 21a, 21b, 21c, with the result that material can be delivered from a corresponding reservoir into the processing head or fed thereto (for the additive building-up). This is advantageously made possible by means of a delivery device 22, or respectively separate delivery devices 22 for each sub-reservoir, wherein the corresponding material can be delivered into the processing head 23 selectively and independently of the delivery of another material. This can be achieved by means known to a person skilled in the art, for example conventional powder-delivering methods, in particular pneumatic devices, pumps or other means.

The delivery device(s) 22, the reservoir(s) 21, under certain circumstances together with a corresponding controller, advantageously make it possible for mutually separated fully automatically or semiautomatically controlled delivery paths to be configured which feed the described materials for the additive building-up of the component 100 selectively via the powder nozzle 24 to a melt pool.

The materials for the additive building-up are advantageously first mixed in the processing head 23 and then, analogously to conventional laser deposition welding, deposited by a powder nozzle 24 on a processing surface or on a substrate (cf. reference sign 6) and melted by means of the welding beam 25 for building-up purposes.

In FIG. 1, the structure 1 for the component 100 is shown as being already (virtually) completely built up on the substrate 6.

In other words, the structure 1 has, according to the described method, been built up, advantageously in layers, along a building-up direction AB by means of the device 20. Here, the dashed horizontal lines in the lower region of the structure 1 in FIG. 1 indicate the individual layers. The stated layers may, for example, already have been depicted or been present in a data model (for example CAD and/or CAM model) for the construction of the component (slicing) relative to its structure 1.

According to the method presented (cf. also FIG. 5), the structure 1 is or has been built up on the substrate 6 from a corresponding pulverulent base material by means of laser deposition welding.

During the additive building-up, an auxiliary structure 2, advantageously consisting of a metal foam, is introduced or built up in an interior, designated by reference sign I, of the structure 1 or of the component 100. The introduction of the auxiliary structure 2 is indicated further below in FIG. 5 by the reference sign b), wherein the stated method step can occur, for example, simultaneously or in layers with the building-up of the structure 1 and also subsequently thereto.

There is thereby advantageously defined or delimited a functional region FB which later becomes necessary for the component or its function during operation. This can occur (additively) in layers just like the actual building-up of the structure 1, wherein the material has to be changed in layers for the corresponding building-up of the layer, under certain circumstances via a corresponding controller and the corresponding activation of the powder-delivering devices 22. For this purpose, there can be required overall in particular a particularly rapid “response” of the powder nozzle 24, of the delivery devices 22 and/or of the processing head 23.

Alternatively, it is also possible at first for a plurality of layers of the structure 1 to be built up additively virtually three-dimensionally and for a thus defined interior or inner region I subsequently to be filled with the auxiliary material 3, for example up to the time at which an overhang 8 must be produced in the structure.

It can be seen from the checkered illustration of the auxiliary structure 2 that what is concerned here is a porous material which has, for example, a porosity of 50% or more. The auxiliary structure 2 has in particular the purpose of supporting the actual structure 1 for the component above the inner region I for the required dimensional stability during the additive manufacturing. The porosity can be selected accordingly and can be, for example, 30%, 40%, 60%, 70% or more.

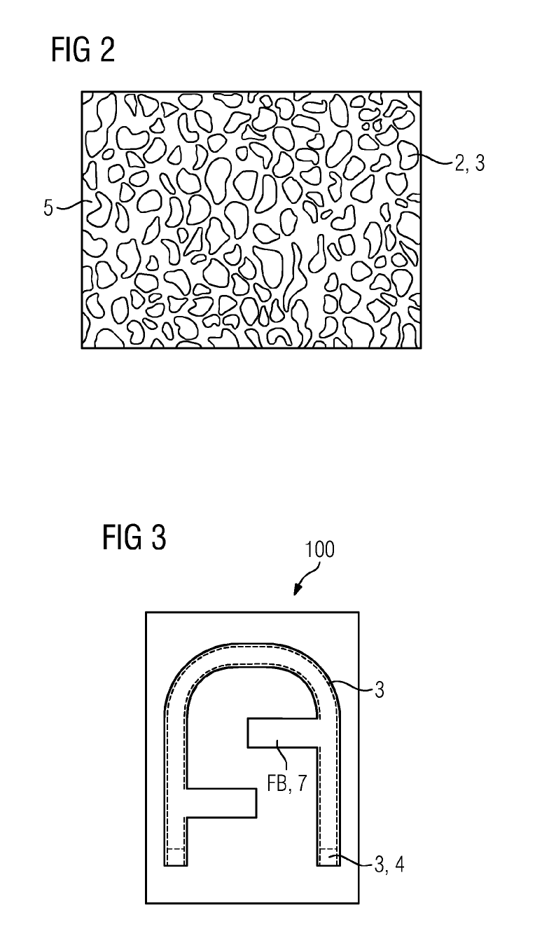

FIG. 2 shows an exemplary structure of the stated auxiliary structure with a porosity which is expedient therefor according to the present invention. According to the illustration of FIG. 2, the porosity can be 50%.

The porous auxiliary structure 2 is in particular formed or built up by virtue of the fact that the stated, in particular metallic, auxiliary material 3 is mixed with the pore former, for example a metal hydride, in the processing head 23 and the corresponding mixture for forming the auxiliary structure 2 is heated above the melting point of the auxiliary material 3. Here, the pore former advantageously evaporates and produces the desired porosity of the auxiliary structure 2. In particular, the porosity can be set the mixing ratio of auxiliary material 3 and pore former and by the correspondingly introduced thermal energy (laser power).

The stated auxiliary material 3 is advantageously a solder material, in particular a high-temperature solder, which can be detached and liquefied again in a subsequent temperature step of the described method (see FIG. 5). The stated high-temperature solder can contain Cu, Co or Ni.

According to the illustration of FIG. 2 (cf. lower region), the component is built up in such a way that an arc-like auxiliary structure 2 has been introduced into an inner region I in a simple rectangular or parallelepipedal geometry of the structure 1. The auxiliary structure 2, and advantageously corresponding inner region I, have, moreover, horizontally extending portions or arms which define corresponding overhangs of the structure 1.

The interior I or the auxiliary structure 2 is expediently covered again with the actual base material (cf. upper region of the component 100 in FIG. 1) in a subsequent building-up phase until completion.

As a departure from the illustration of FIG. 1, it is possible for the component 100, its structure 1 and/or the auxiliary structure 2 introduced into the inner region I or the fusion region FB to have any individually desired shape or geometry, for example a shape already predetermined by the construction of the component. In particular, the inner region I, which, according to the present invention, is occupied temporarily, i.e. advantageously completely by the auxiliary structure 2 during the manufacturing, can be provided for a cooling duct structure (not explicitly indicated) via which the component 100 can be expediently traversed during operation by a cooling fluid for cooling. For this purpose, the structure 1 is advantageously built up in such a way that a fluid inlet and/or a corresponding outlet are or is provided for the component.

The method further comprises the detachment or removal (cf. method step c) in FIG. 5), in particular the melting or melting-out of the porous material of the auxiliary structure from the fusion region FB by heating the auxiliary structure, in particular after the structure 1 has been completely built up, with the result that the functional region FB is freed from the auxiliary structure.

For this purpose, the device 20 can have a heating device 27 which is likewise schematically indicated in the lower region of FIG. 1. The heating device 27 can be an inductive device, for example an induction furnace, in order to heat the structure 1, but in particular the auxiliary structure 2, to expediently high temperatures after the described additive building-up, for example in such a way that the auxiliary structure can be melted down. Temperatures of above 700° C., advantageously of about 800° C., particularly advantageously of above 900° C. or more, are advantageously reached for removing the auxiliary structure from the functional region FB.

Alternatively, the heating device can be a device which is separate from the described device 20.

FIG. 3 shows the component 100 or its structure 1, wherein, by virtue of the described removal, in particular by means of a high-temperature treatment or high-temperature soldering, the auxiliary structure 3 has been removed from the functional region FB by liquefaction (cf. method steps c) in FIG. 5). Correspondingly, FIG. 3 advantageously shows a complete or substantially completely manufactured state of the component 100.

The described melting down of the auxiliary structure 2 means that it necessarily loses its dimensional stability, its original volume and also its supporting action for the structure 1. The melted-down material of the auxiliary structure 2 can remain, for example, on or in portions of the inner region I. Accordingly, the functional region FB is advantageously completely arranged in the inner region and/or constitutes a subregion of the inner region I.

The greater the porosity, the greater can subsequently be the functional region FB, since more volume (gas volume) is available for forming the hollow or functional region FB on account of the greater porosity.

It is indicated in particular by the dashed lines in FIG. 3 that the, in particular metallic, auxiliary material 3, i.e. the melted-down material of the auxiliary structure, remains on inner walls of the structure 1 or of the inner region I or accumulates there. Alternatively or in addition, the auxiliary material 3 can be at least partially received in regions “pockets” provided therefor (likewise dashed and indicated by reference sign 4 in FIG. 3), into which regions said material flows, for example, after liquefaction under the influence of gravitation.

Alternatively, the complete building-up of the structure 1 for the component 100 can be carried out according to the invention in such a way that the component 100 has at least one inlet and/or outlet 4 which is fluidically connected to the interior I. The auxiliary material can then advantageously likewise be removed from the inner region I through the inlets and/or outlets 4 provided in the structure, and thus an even greater volume for the fusion region can be made available.

The stated inlet and/or outlet 4 can be provided at the position(s) of the pockets or receiving regions.

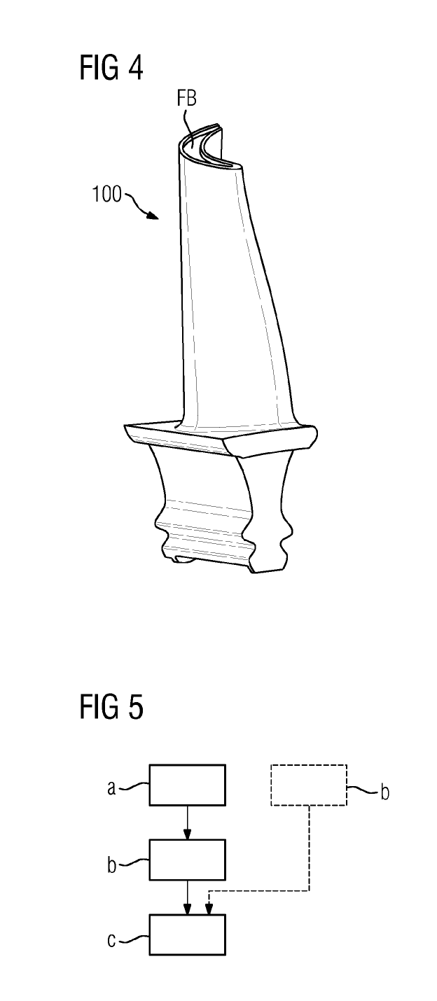

FIG. 4 shows, merely as an exemplary embodiment, a turbine blade, for example a guide blade or rotor blade of a gas turbine, as component 100. At the tip of the component 100 there is shown an inner region or cavity which constitutes the described functional region FB. In this context, the turbine blade shown can be provided with an inner cooling duct or cavity using the described method, with the result that the blade can be expediently cooled, for example, for an operation of the gas turbine.

As an alternative to the turbine blade shown, the component 100 can be, for example, another component which is used in the hot-gas path of a gas turbine, for example a burner component or a part of a combustion chamber wall of the turbine.

Although not explicitly shown in the presently described figures, the described method and/or the corresponding component can be characterized by the additive deposition of further materials, for example oxidation protection layers (MCrAlX) and/or thermal insulation layers.

Furthermore, it is possible within the scope of the described invention—as an alternative to the described welding methods—to use further coating methods, such as, for example, electron beam evaporation (EB-PVD) or atmospheric plasma spraying (APS), LPPS, VPS or CVD, insofar as the described concept according to the invention with metallic foam as porous auxiliary structure can be applied thereto.

The invention is not limited by the description on the basis of the exemplary embodiments to said embodiments, but encompasses any novel feature and any combination of features. This includes, in particular, any combination of features in the patent claims, even if this feature or this combination itself is not explicitly specified in the patent claims or exemplary embodiments.

1.-11. (canceled)

12. A method for additive manufacturing of a component, comprising:
additive building up of a structure from a base material for the component by an additive manufacturing method,
introducing a porous auxiliary structure consisting of a metal foam into an interior of the structure during the additive building up of the structure in order to define a functional region for the component in the interior, wherein the additive building up of the structure and/or the introducing of the porous auxiliary structure are or is carried out by laser deposition welding or micro cladding, wherein, to form the porous auxiliary structure, a metallic material for the porous auxiliary structure is mixed with a pore former, and wherein the corresponding mixture for forming the porous auxiliary structure is heated above a melting point of the metallic material, and the pore former is evaporated, and
detaching the porous auxiliary structure from the functional region by heating the porous auxiliary structure, with a result that the functional region is freed from the porous auxiliary structure.

13. The method as claimed in claim 12,
wherein parts of the structure and of the porous auxiliary structure are alternately built up in layers.

14. The method as claimed in claim 12,
wherein the porous auxiliary structure is introduced into the interior in such a way that the porous auxiliary structure supports the structure for the component.

15. The method as claimed in claim 12,
wherein a material of the porous auxiliary structure remains in the interior of the component.

16. The method as claimed in claim 12,
wherein the structure for the component is built up in such a way that the component has at least one inlet and/or outlet which is fluidically connected to the interior, and wherein the structure is formed in such a way that the porous auxiliary structure is removeable in a simple manner from the interior by melting.

17. A component which is produced or can be produced by the method as claimed in claim 12,
wherein the component is a high temperature resistant and/or highly heatproof component for use in a turbomachine,
wherein the functional region is provided to be traversed by a fluid for cooling, and wherein the functional region is at least partially defined by a material.

18. A device for the additive manufacturing of a component by the method as claimed in claim 12, the device comprising:
a reservoir for separate storage of a base material for the component, of a material and of a further material,
a processing head which is connected to the reservoir, wherein the processing head is further designed for guiding a welding beam, and in such a way as to selectively deposit the base material, and/or the further material on a processing surface and to melt said materials, wherein the device is a beam welding device for laser deposition welding or micro cladding, and
a delivery device for selectively delivering the base material, the material of the porous auxiliary structure, and the further material into the processing head.

19. The device as claimed in claim 18, further comprising:
a heating device which is designed to heat a structure of the component to a temperature of at least 800° C.

20. The device as claimed in claim 19,
wherein the heating device is an inductive heating device.

21. The method as claimed in claim 12,
wherein the pore former is a metal hydride.

22. The method as claimed in claim 12,
wherein the detaching comprises melting the porous auxiliary structure from the functional region by heating the porous auxiliary structure.

23. The component as claimed in claim 17,
wherein the functional region is at least partially defined by a metallic material.

24. The device as claimed in claim 18,
wherein the material is a metallic material.

25. The device as claimed in claim 18,
wherein the welding beam is a laser or electron beam.
